(19) United States
(12) Patent Application Publication
(10) Pub. No.: US 2022/0414737 A1
(43) Pub. Date: Dec. 29, 2022

(54) QUERY-BASED PRODUCT REPRESENTATIONS

(71) Applicant: Microsoft Technology Licensing, LLC, Redmond, WA (US)

(72) Inventors: Jiayao WANG, Redmond, WA (US); Karthikeyan ASOKKUMAR, Bellevue, WA (US); Emre Hamit KOK, Kirkland, WA (US); Pushpraj SHUKLA, Dublin, CA (US); Mohan SUNDERAM, Bothell, WA (US)

(21) Appl. No.: 17/359,915

(22) Filed: Jun. 28, 2021

(51) Int. Cl. G06Q 30/06; G06N 20/00

(52) U.S. Cl. CPC G06Q 30/0627; G06N 20/00

(57) ABSTRACT

A method for managing query-based product representations includes receiving product data supplied by a product supply entity, wherein the product data is associated with one or more products for which the product supply entity provides information, generating a product representation generator for the product supply entity from a query representation generator including a machine learning model, wherein the product representation generator is trained from the query representation generator based on a portion of the product data, wherein the query representation generator was trained from a representation generator template based on user query data supplied by a search provider, wherein the query representation generator is generic across multiple product supply entities, and providing the product representation generator specific to the product supply entity, wherein the product representation generator is operable to relate a product data representation generated by the product representation generator to relevant search queries.

### BACKGROUND

Users search the Internet for information. Some queries are associated with product purchases. Product supply entities with online presence often rely on digital marketing to provide users with products that satisfy the needs of the users. Search providers receive data from users and help product supply entities provide the products.

### SUMMARY

The described technology provides implementations of systems and methods for managing product representations. More specifically, the described technology provides implementations of systems and methods for managing query-based product representations.

A method for managing query-based product representations is provided. The method includes receiving product data supplied by a product supply entity, wherein the product data is associated with one or more products for which the product supply entity provides information, generating a product representation generator for the product supply entity from a query representation generator including a machine learning model, wherein the product representation generator is trained from the query representation generator based at least in part on a portion of the product data, wherein the query representation generator was trained from a representation generator template based at least in part on user query data supplied by a search provider, wherein the query representation generator is generic across multiple product supply entities, and providing the product representation generator specific to the product supply entity, wherein the product representation generator is operable to relate a product data representation generated by the product representation generator to relevant search queries.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example system for providing product-related information.

FIG. 2 illustrates an example system for generating a query representation generator.

FIG. 3 illustrates an example system for generating a product representation generator from a query representation generator.

FIG. 4 illustrates another example system for generating a query representation generator.

FIG. 5 illustrates another example system for generating a product representation generator.

FIG. 6 illustrates an example system for generating product information from a product query.

FIG. 7 illustrates example operations of providing a product representation generator.

FIG. 8 illustrates example operations of providing product information associated with a product representation.

FIG. 9 illustrates an example computing device for implementing the features and operations of the described technology.

### DETAILED DESCRIPTIONS

Search providers receive user queries including searches, generated search results, and user selections among the results. The searches often target types of products for purchase or relate to products to be purchased. Search providers can provide data that characterizes the types of searches and predict related products. Product supply entities often rely on the search providers to advertise using the generated search results. However, product supply entities also generate local product supply entity data that could be relevant to user product decisions that can contribute or even outperform results generated from search providers. Further, the models used for prediction often conform to different structures, potentially complicating the process of synchronizing the query-based data and product data from the product supply entity. This can limit or prevent capitalizing on synergies between the query-based data and the product data from the product supply entity. Also, local product supply entity data is typically based on current inventory and known purchase histories. Query-based data is often available before a product is even released, perhaps in anticipation of the release. Product supply entity inference models for characterizing and predicting products for users can be limited to products already purchased and/or products already in inventory. In addition, computing systems controlled by product supply entities often classify products and product inquiries by human-generated classification systems, such as IDs assigned by people to classes of products. The human-generated classifications can be informative but lack the context and rich deep relationships large quantities of query data represent.

In accordance with the presently described technology, a service can provide a product supply entity with specific inference models that generate product representations, perhaps based on both query-based data provided by a search provider and product data provided by a product supply entity. By leveraging these sources of data, the product supply entity can better predict purchase behaviors of users and/or provide better results for product queries in a product supply entity-specific environment.

In an implementation, a search provider or other service entity that receives data from the search provider can generate a query representation generator that can generate product representations based at least in part on user queries received and/or transmitted by the search providers. The query representation generator can be trained with user query data. Examples of user query data can include one or more of user searches, search results, user and selections of search results. The received user queries can be distinguished by search intent to exclude user queries that are not product-related. The product-related search queries can include one or more search strings. The search strings can be classified and assembled based on a common characteristic (e.g., a common user, a device, a user identifier, a device identifier, a product type, product data, an accessory of a product). The strings with the common characteristic can be concatenated or otherwise grouped to make grouped strings, perhaps limited to a certain length. In implementations, the strings are windowed in input fields, limiting the number of and/or length of query strings in a grouped string. Grouped strings can be tokenized or otherwise vectorized to occupy a predefined dimension, the predefined dimension based at least in part on an input size specific to the query representation generator. A grouped string that has been vectorized can be input into the query representation generator, and the query representation generator can output a query representation. A modified group string can be generated by ignoring part of the grouped string, perhaps by masking part of the string. In an implementation, the part ignored is one of the user query strings, but implementations are considered where parts of query strings are ignored. The modified group string can be inputted into the query representation generator, and the output model could generate an output a modified query representation. The query representation and the modified query representation can be compared, and the query representation generator can be trained by reducing the difference or loss between the representations, perhaps by backpropagating the difference or losses through a neural network or other machine learning model or inference model. The query representation generator can be further trained by generating a different modified query representation based on a different modified group in which different string elements of the group are ignored and minimizing the difference or loss between the different modified query representation and one or more of the query representation and the modified query representing. This procedure can be repeated with a number of groups. One or more of the tokenization, grouping, and training can incorporate or otherwise account for ordering or hysteresis of data associated with the search queries.

The query strings can include accompanying click or selection data. For example, the search provider can track user selections of results yielded from a search string. This selection can include associations with the search strings that yielded the selected results, and stored as an input to be fed into the query representation generator with corresponding grouped string data. In implementations, the click data can also be similarly modified to ignore certain elements and predict the elements using loss or difference reduction functions (e.g., backpropagation of loss through a neural network).

A trained query representation generator can be operable to provide an output for any string input. This can include any product data that is initially formatted into a string or even using product numbers that can be similarly associated and tokenized. The trained query representation generator can provide a rich model from which to build product supply entity-specific product representation models. Training the query representation generator with general product queries across demographics of users (e.g., age, gender, location, and rural or urban location), product categories, and/or purchase behaviors (e.g., seasonal aspects of searches, frequency of a search query or queries related to a product, and their relationship to purchase history) can inferentially link elements of search queries with potential product results in the query representation generator. Examples of inferential linking elements can include one or more context of the query strings, writing styles of the user, the type of user that authored search query string, the types of products the user or type of user prefers, the likelihood the user will purchase a product, the spending habits of the user or type of user, user demographics issues or features that interest the user.

Product supply entities often generate data regarding products. For example, product supply entities generate data about product features, data for identifying products, general purchase data for products, user-specific purchase history data (perhaps include hysteresis or orders of purchases), and seasonal purchase data. The data can be useful for answering product-specific queries made to a product supply entity-specific client, but the data can also include deficiencies, such as potentially including limited data on newer products and products about to be released. The data can be supplemented using the query-based inferential context built into the query representation generator.

The product supply entity, a multi-product supply entity service that services the product supply entity, or other service entity that provides service to the product supply entity can use the query representation generator as a context-rich template model for producing a product representation generator to relate product information with greater context. The service entity can generate the product representation generator from the query representation generator by training the query representation generator with product supply entity-provided product data. The training of the product representation generator can include generating a product representation by inputting product data into the query representation generator and outputting a product representation. The product data can be processed and input into the query representation generator similarly to the manner in which the query data was processed and input into the query representation generator. The product data can be apportioned into data portions (e.g., similarly to the groups of queries) and modified portions of the data can be generated. The product data can be apportioned based on characteristics. These characteristics can include, without limitation, one or more of product features, data for identifying products, general purchase data for products, user-specific purchase history data (perhaps include hysteresis or orders of purchases), seasonal purchase data, retailers of the product, location of product supply and/or sales, popularity of the products, demographics of those who purchase and/or express interest in the product, seasonal popularity of the products, month of the year of query and/or purchase, weather data, and online or offline purchasing of the product. The training can include comparing product representations and modified product data representations and minimizing loss between the representations, perhaps by backpropagating loss in a neural network, other machine learning algorithms, or other inferential model. The training can generate the product representation generator from the query representation generator. The resulting product representation generator can provide the benefit of contextual learning from both general search queries from a search provider and in-house product data from a product supply entity.

In implementations, outputs of one or more of the product representation generator and query representation generator can be of a predefined dimension, perhaps a vector of a predefined dimensionality (e.g., conforming to a predefined length and/or conforming values to a predefined range). The product representations can be of a same dimensionality as the query product representation, making the representations input-string-length-invariant output vectors.

In implementations, the dimensionality of inputs to one or more of the product representation generator can be the same. Strings of different lengths can be accommodated by filling the remaining space in a vector with values. Examples of these values can include one or more of zeroes (e.g., padding), repeating sequences of the input strings, and reordered elements of the input strings.

The presently disclosed technology can provide advantages over existing systems. One advantage is that context in search results benefit from contextual linking between generic query data supplied by search engines and product data supplied by product supply entities. This can contextually relate generic search queries with product supply entity-specific data. The product representations can also be uniformly dimensioned with other queries, such that any input into a product representation generator can be output in a uniform, easily comparable product representation. Also, with new products or products about to be released, product supply entities may have no data because the products have yet to be sold and/or inventoried in the computing systems used by the product supply entities. The context of the query data can provide a good starting point for these new products. Similarly, new product supply entities that lack significant amounts of product-related data can begin with a context-rich model trained on search queries that is contextually related to the products the new product supply entities supply or are likely to supply. Also, the representations can be used in other systems that would typically receive product data as input. For example, one or more of product recommenders, customer lifetime value analyzers, and churn analyzers can utilize the representations instead of or in addition to existing product identifiers or associations.

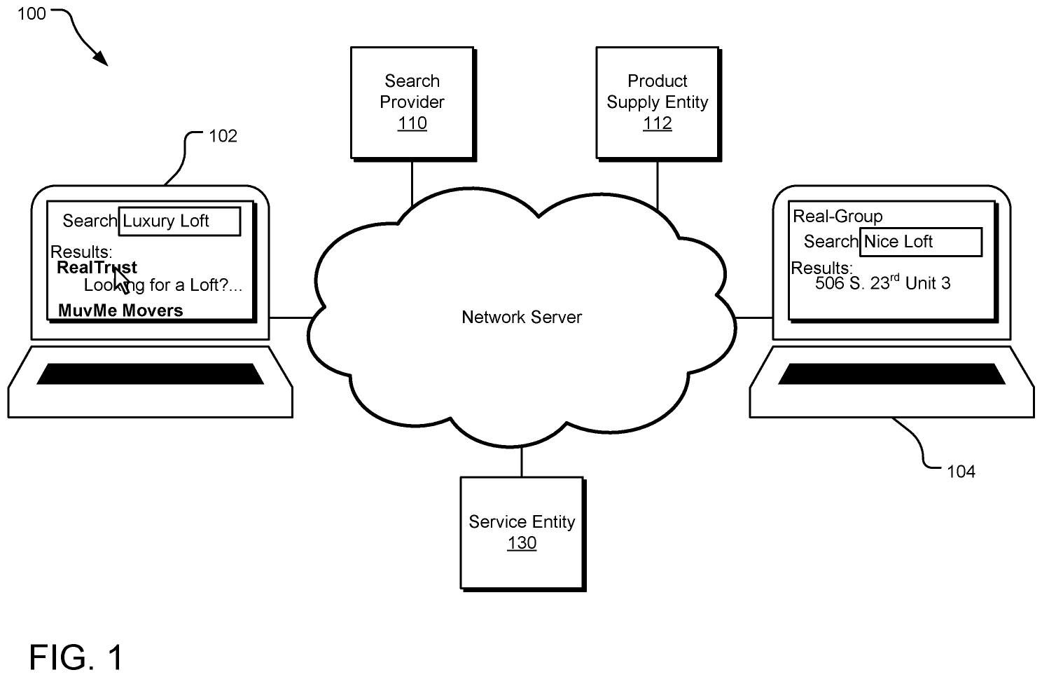

FIG. 1 illustrates an example system 100 for providing product-related information. System 100 transfers user search queries from a first user computer 102 to a search provider 110. The search query can include one or more of the search string, “Luxury Loft”, results supplied, and a result selected (“RealTrust,” as indicated by the illustrated cursor). A service entity 130 requests and receives the search query from the search provider 110. The service entity 130 is an entity that provides product representation services for one or more product supply entities. The service entity 130 takes a representation generation template (e.g., an inference or machine learning module) and trains it using the received search queries to make a generic query representation generator. The generic query representation generator can be generic to one or more of queries, products, and multiple product suppliers. The generic query representation generator can generate an output that represents or otherwise characterizes generic query inputs. This output can be a vector representation that can be compared in a similar or same dimensionality as other representations. The generic query representation generator may learn the context of queries including relationships between generic queries and generic products. In an implementation, the generic query representation generator is generic across multiple product supply entities

The service entity 130 can also receive product data from a product supply entity 112. The product supply entity supplies 112 products to users. Examples of products represented with or otherwise associated with the product data include goods, services, real estate, and financial services. The product data can be associated with one or more products for which the product supply entity provides information and/or which the entity supplies or plans to supply to users. The service entity 130 can generate a product representation generator from the generic query representation generator based at least in part on the product data.

The service entity 130 can provide the product representation generator to generate product representations of data that is input into the product representation generator. The product representation generator can relate the product data representation to relevant search queries. For example, the second user computing system 104 displays that a user is on a website of a specific product supply entity 112, “Real-Group.” The user of user computing system 104 has made a product query for a “Nice Loft.” The product query can be submitted from the product supply entity 112 to the service entity 130. The service entity 130 uses the product representation generator to generate a product representation. One or more of the product supply entity 112 and the service entity 130 has a product representation interpreter that compares the product representation generated from the product query and compares the product representation with existing product representation. The product representation interpreter provides product-related information associated with existing product representations similar to the product representation generated from the product query. The results can be transmitted to the second user computing system 104. The result displayed shows an address of a loft at 506 S. 23^{rd}, Unit 3. It can be appreciated that, despite the search query from the first user computer 102, “Luxury Loft,” being different from the search from the product query from the second user computing system 104, “Nice Loft,” the product representation generator has been trained to generate results based on the contextual similarity between the searches. The contextual similarity is provided by the training the generic query representation generator from the representation generator template using generic search query data and the training the product representation generator from the generic representation generator using the product data. Because the product data is specific to the product supply entity 112, the resulting product representation generator can be specific to the product supply entity 112.

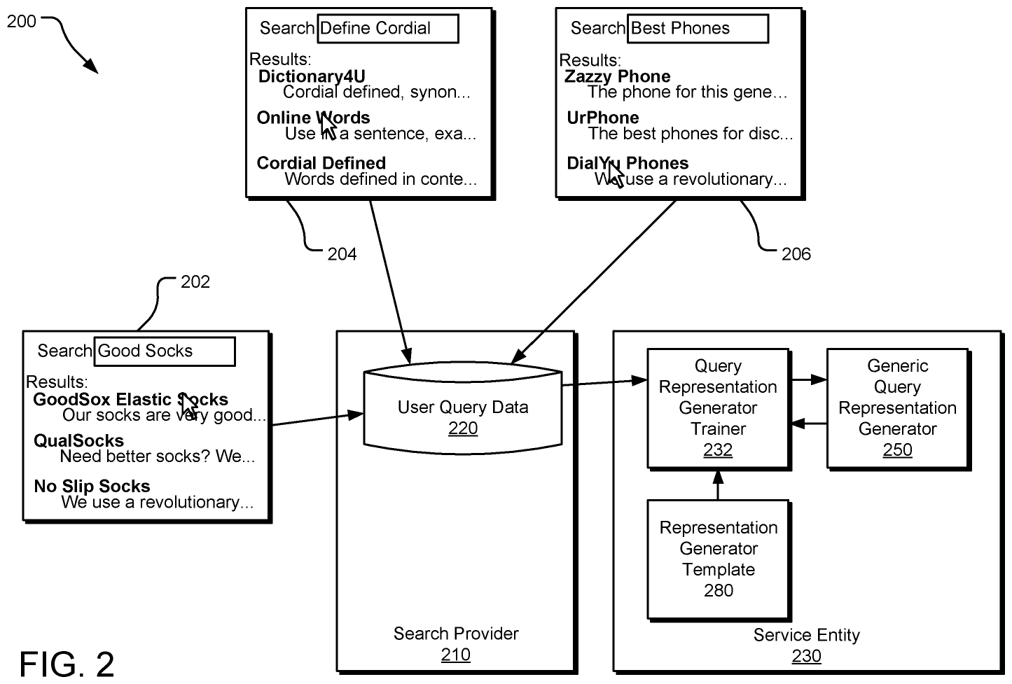

FIG. 2 illustrates an example system 200 for generating a generic query representation generator 250. The system 200 illustrates a first search query 202, a second search query 204, and a third search query 206. The first search query 202 includes a string, “Good Socks.” Results yielded include “GoodSox Elastic Socks,” and, as indicated by the cursor, the user selected this result. The second search query 204 includes a string, “Define Cordial.” Results yielded include “Online Words,” and, as indicated by the cursor, the user selected this result. The third search query 206 includes a string, “Best Phones.” Results yielded include “DialYu Phones,” and, as indicated by the cursor, the user selected this result. The search queries 202, 204, 206 can cause a search provider 210 to generate user query data 220 representing one or more of the search query string, the results yielded, a result selected, any uniform resource locators (URLs) or other metadata associated with the results or selected result, and user-specific data regarding any element of the query. The search provider 210 can store the user query data 220. The search provider can process and store this data using a computing device (e.g., a server). As used in this specification, search strings can include any strings associated with the search. For example, the search strings can include one or more of strings representing text of a search, text of results, text of classifiers, text of URLs, text representing selection/click data (e.g., selection/click data that can include elements of a click graph, snippets of the page in a clicked URL, and the query with which to associate the selection/click data). Implementations are contemplated where other sources of information provide information other than query data. For example, search query data in the systems and methods disclosed herein can be substituted with or supplemented by data representing browsing activities in different entities (e.g., data that can be purchased or provided by third parties other than a product supply entity for which a product representation generator is created), social media searches, and other third party data.

A service entity 230 can receive the user query data 220 from the search provider, perhaps in a service entity 230 computing device (e.g., a server). Implementations are contemplated in which the search provider and the service entity are the same or different entities and/or conduct computational operations on the same or different computing device network. The service entity 230 can include a query representation generator trainer 232 executable by a processor of a computing device of the service entity 230 to train a generic query representation generator 250, perhaps based at least in part on the received user query data 220. The service entity 230 computing device can store the generic query representation generator 250 in memory of the service entity 230 computing device.

The query representation generator trainer 232 can process the user query data 220 before using the user query data 220 to train the generic query representation generator 250. In an implementation, the query representation generator trainer 232 can classify the user query data 220 to exclude data that is not product-related. For example, search queries 202 and 206 suggest a user intends to find a product. The second search query 204 is for a definition of the word, “Cordial.” The query intent of the second search query 204 is likely not to find a product. The query representation generator trainer 232 can determine to exclude any data associated with the second search query 204 when training the generic query representation generator 250. Query intent is a label associated with a user's intent in making a search query. The query intent can represent a cluster of vector representations of queries that are similar or close in a vector space. The query intent can be based on an association between queries made and results provided and/or selected. When a user searches and provides a responsive selection, the selection can be associated with the search, for example, in a click graph. In an implementation, the query intent can distinguish between product-related searches and other informational searches.

In an implementation, the query representation generator trainer 232 can process the data by grouping the user query data 220. The user query data 220 can be classified based on a common characteristic of groups of the user query data 220. For example, grouping can be based on one or more of the user that generated the search query, the device that generated the search query, identifiers representing one or more of the device and user, a product classifier or category, a timing or order of queries (e.g., a request time), a query classifier (e.g., one generated by the search provider 210), user age, user gender, user location, user language, time of query and/or purchase, and a window of time during which the query and/or purchase is made(e.g., month or season). The grouping can include an ordered or hysteresis component in which the ordering of the user query data 220 grouped in the group is controlled. In implementations, the data can be grouped in chronological order to reflect the hysteresis.

In implementations where the common characteristic (e.g., for grouping user query data 220 or for apportioning product data) includes a user, user identifier, user device, or user device identifier, a generic query representation generator 250 can learn user behavior for the type of user. Implementations where a common characteristic includes a product identifier or classifier, a generic query representation generator 250 can learn similarities of products and behavior and use patterns associated with the products identified or classified.

The user query data 220 can include search strings. In an implementation, the query representation generator trainer 232 can represent elements of the search strings by tokenizing the search strings. Tokenization can standardize and/or vectorize the elements of the search strings to make the elements more ingestible by representation generators.

In an implementation, the user query data 220 are grouped based at least in part on a number of and/or length of the search strings(e.g., the group is windowed into further smaller groups). For example, each group can include a certain number of search strings combined into a combined string (e.g., by concatenation). Another example is that the group can include a certain length of a combined string composed of search strings that are combined. The combined string can be augmented to result in a string of a predefined length. Generating an input string of a predefined length can potentially benefit the training, as the dimensionality can be important for inputting the combined string into a generic query representation generator 250.

In an implementation, the query representation generator trainer 232 can use the processed groups of search query strings to train the generic query representation generator 250. The query representation generator trainer 232 can begin with a representation generator template 280 with random weighting of different elements or can begin with a pre-trained representation generator template 280 model, perhaps trained in a different or similar context. The representation generator template can be an inference model. The query representation generator trainer 232 can generate output for a group. The output can be a vector of a predefined length. The query representation generator trainer 232 can modify the group by ignoring some of the data in the group. The data ignored can be data representing one or more search strings or elements of one or more search strings.

The query representation generator trainer 232 can input the modified group into the generic query representation generator 250 to generate an output for the modified group. The output of the group and the output of the modified group can be compared (e.g., a distance between vectors can be calculated), and the loss or difference can be minimized (e.g., by propagating the loss through the generic query representation generator 250). This process can be continued within a group by making a different modified group, inputting the different modified group into the generic query representation generator 250, comparing the output of the different modified group with one or more of the output of the group and the output of the modified group, and minimizing the difference or loss (e.g., by backpropagating the loss through the generic query representation generator 250). This process can be repeated for this and other groups any number of times.

The result of the training can be a generic query representation generator 250 capable of producing a query representation for any query input. The generic query representation generator 250 can include a dimensionality including dimensions for inputs of grouped query data and dimensions for output query representations. In implementations, outputs of the generic query representation generator 250 can be of a predefined dimension, perhaps a vector of a predefined dimensionality (e.g., conforming to a predefined length and/or conforming values to a predefined range). The product representations can be of a same dimensionality as the query product representation, making the representations input-string-length-invariant output vectors.

In implementations, the generic query representation generator 250 can be an inference model and/or a machine learning model. In this specification, examples of machine learning or inference models can include, without limitation, one or more of data mining algorithms, artificial intelligence algorithms, masked learning models, natural language processing models, neural networks, artificial neural networks, perceptrons, feed-forward networks, radial basis neural networks, deep feed forward neural networks, recurrent neural networks, long/short term memory networks, gated recurrent neural networks, auto encoders, variational auto encoders, denoising auto encoders, sparse auto encoders, Bayesian networks, regression models, decision trees, Markov chains, Hopfield networks, Boltzmann machines, restricted Boltzmann machines, deep belief networks, deep convolutional networks, genetic algorithms, deconvolutional neural networks, deep convolutional inverse graphics networks, generative adversarial networks, liquid state machines, extreme learning machines, echo state networks, deep residual networks, Kohonen networks, support vector machines, federated learning models, and neural Turing machines. In implementations, the query representation generator trainer 232 trains the generic query representation generator 250 by an inference model training method. In this specification, examples of training methods (e.g., inferential and/or machine learning methods) can include, without limitation, one or more of masked learning modeling, unsupervised learning, supervised learning, reinforcement learning, self-learning, feature learning, sparse dictionary learning, anomaly detection, robot learning, association rule learning, manifold learning, dimensionality reduction, bidirectional transformation, unidirerctional transformation, gradient descent, autoregression, autoencoding, permutation language modeling, two-stream self attenuation, federated learning, absorbing transformer-XL, natural language processing (NLP), bidirectional encoder representations from transformers (BERT) models and variants (e.g., RoBERTa, XLM-RoBERTa, and DistilBERT, ALBERT, CamemBERT, ConvBERT, DeBERTA, DeBERTA-v2, FlauBERT, I-BERT, herBERT, BertGeneration, BertJapanese, Bertweet, MegatronBERT, PhoBERT, MobileBERT, SqueezeBERT, BART, MBART, MBART-50BARThez, BORT, or BERT4REC), Allegro, cross-lingual language model (XLM) and variants (e.g., XLNet, XLM-ProphetNet, XLSR-Wav2Vec2, and Transformer XL), Auto Classes, BigBird, BigBirdPegasus, Blenderbot, Blenderbot Small, CLIP, CPM, CTRL, DeiT, DialoGPT, DPR, ELECTRA, Encoder Decoder Models, FSMT, Funnel Transformer, LayoutLM, LED, Longformer, LUKE, LXMERT, MarianMT, M2M100, MegatronGPT2, MPNet, MT5, OpenAI GPT, OpenAI GPT2, GPT Neo, Pegasus, ProphetNet, RAG, Reformer, Speech2Text, T5, TAPAS, Vision Transformer (ViT), OpenAI, GPT3, and Wav2Vec2.

Multiple instances of the generic query representation generator 250 can exist simultaneously within the computing device(s) of the service entity 230. Implementations are contemplated in which the service entity continuously and/or periodically updates the generic query representation generator 250. The generic query representation generator 250 can also be trained on product data used to generate a product representation generator. Implementations are contemplated where one or more of the generic query representation generator 250 and a product representation generator can be coalesced to affect the other.

In an implementation, the generic query representation generator 250 is trained using an inference method including an XLMRoBERTa model, and a product representation generator is trained using a BERT4REC model. Implementations are contemplated in which a query representation can be further processed as part of other Out-of-The-Box (OOB) models. The OOB models can include ones for product recommendations, customer lifetime value, and churn to initialize the product representation in those models. The product or query representations can also be concatenated together to enrich the representation of a user using sequences of the user's product search.

In implementations, OOB models used for product recommendations, CLV, and churn take a user's purchase history as input of the model. The corresponding products may be input into the OOB model as the representation generated by the product representation generator 250 (e.g., as opposed to a contextless unique ID). This may provide the advantage that the representation has inborn context provided by the training of the product representation generator 250. In implementations, when a system has data representing multiple queries and/or purchases of a single user, a representation of the user can be made by coalescing or otherwise combining the representations of the queries and/or purchases (e.g., by averaging, taking a median of, or performing other combining algorithms on vector values of the representations). The resulting combined or coalesced representation may represent a characteristic representation of the user. This may provide a holistic aggregation of user search patterns and purchase history. A cohort (e.g., age, gender, location, or other demographic to which the user belongs) of the user can be inferred from demographic information and a representation can be used as a representation of the cohort and its members. In an implementation, the representation can capture recurring user activities, which can potentially be used to predict the churn of services.

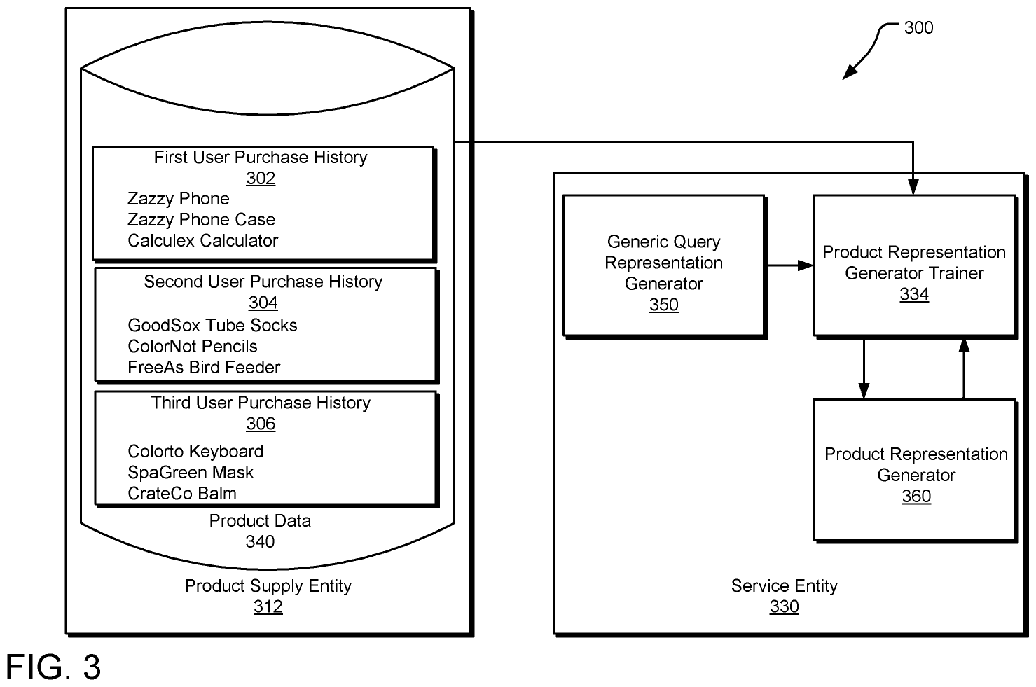

FIG. 3 illustrates an example system 300 for generating a product representation generator 360 from a generic query representation generator 350. A product supply entity 312 is an entity that sells products to consumers. The product supply entity 312 controls a computer device (e.g., a server) that stores product data 340 in a memory device of the computing system. Examples of product data 340 can include data representing one or more of product features, data for identifying products, general purchase data for products, user-specific purchase history data (perhaps including hysteresis or orders of purchases), and seasonal purchase data. In the illustrated implementation, the product data can include data representing a first purchase history 302 associated with a first user, a second purchase history 304 associated with a second user, and a third purchase history 306 associated with a third user. The product data is not necessarily related but can be. For example, purchase histories 304 and 306 show little connection between the purchased items. However, the first purchase history 302 includes a Zazzy brand phone, a Zazzy brand phone case, and a Calculex calculator. The Zazzy phone case and the Zazzy phone are likely related purchases the first user would make.

The service entity 330 is an entity that provides product representation generation services for the product supply entity 312. The service entity 330 can store a preexisting trained generic query representation generator 350 that can be static at an initial time of generation or updated by a query representation generator trainer over time. The service entity 330 can transmit or transfer the generic query representation generator 350 to the product representation generator trainer 334. The product representation generator trainer 334 can use the generic query representation generator 350 as a base model (e.g., pre-trained model) from which to train and generate the product representation generator 360. In an implementation, the product representation generator 360 is a product supply entity-specific product representation generator 360 that is specific to the product supply entity 312. For example, the product data 340 used to train the product supply entity-specific product representation generator 360 is product data 340 supplied by the product supply entity 312.

The product representation generator trainer 334 can receive the product data 340 from the product supply entity 312 to further train the generic query representation generator 350 to generate the product representation generator 360. The product representation generator trainer 334 can take process the product data 340 to prepare the product data 340 for ingestion in the product representation generator 360.

The product representation generator trainer 334 can process the product data 340 before using the product data 340 to train the product representation generator 360. In an implementation, the product representation generator trainer 334 can process the data by apportioning the product data 340. The product data 340 can be classified based on a common characteristic of portions of the product data 340. For example, apportioning can be based on one or more of the user that purchased the product, the device the user used to purchase the product, identifiers representing one or more of the device and user, a product identifier or category, queries within the product supply entity environment (e.g., product-related search strings in the product supply entity's system), location of products, seasonality of products, products typically purchased with the product (perhaps even with the same or similar order of purchase), mode of purchase (e.g., payment method, retailer, retailer location, online or offline purchase), and a timing or order of purchases or product queries (e.g., a request time). The apportioning can include an ordered or hysteresis component in which the order of the product data 340 apportioned in the portion of the product data 340 is controlled. In implementations, the data can be grouped in chronological order to reflect the hysteresis.

The product data 340 can include strings. In an implementation, product representation generator trainer 334 can represent elements of the product data 340 by tokenizing product data 340 strings. Tokenization can standardize and/or vectorize the elements of the product data 340 strings to make the elements more ingestible by representation generators.

In an implementation, the product data 340 is apportioned based at least in part on a number of and/or length of the product data 340 strings, or windowed. For example, each portion can include a certain number of product data 340 strings combined into a combined string (e.g., by concatenation). Another example is that the portion can include a certain length of combined string composed of product data 340 strings that are combined. The combined string can be augmented to result in a string of a predefined length. Using an input string of a predefined length, even if extended with padding or repeated data from the string, can potentially benefit the training, as the dimensionality can be important for inputting the combined string into a product representation generator 360.

In an implementation, the product representation generator trainer 334 can use the processed portions of product data 340 strings (e.g., a product data portion) to train the product representation generator 360. The product representation generator trainer 334 can begin with the generic query representation generator 350 as a base inference model. The generic query representation generator 350 can be pre-trained to include weighting of elements reflecting search query data. The product representation generator trainer 334 can generate output for the product data portion, perhaps a product data portion representation. The output can be a vector of a predefined length. The product representation generator trainer 334 can modify the portion by ignoring some of the data in the portion. The data ignored can be data representing one or more product data 340 strings or elements of one or more product data 340 strings.

The product representation generator trainer 334 can input the modified product data portion into the initial generic query representation generator 350 (e.g., that, when trained with the product data 340 can become the product representation generator 360) to generate as output a modified product data portion representation. The output of the portion and the output of the modified portion can be compared (e.g., a distance between vectors can be calculated), and the loss or difference can be minimized (e.g., by propagating the loss through the generic query representation generator 350). The product representation generator trainer 334 can make a different portion by ignoring different elements of the portion. This process can be continued within a portion by making the different modified portion, inputting the different modified portion into the generic query representation generator 350, comparing the output of the different modified portion with one or more of the output of the portion and the output of the modified portion, and minimizing the difference or loss (e.g., by backpropagating the loss through the generic query representation generator 350). This process can be repeated for this and other portions any number of times.

The result of the training can be a product representation generator 360 with a capability of producing a product representation for any product data 340 input. The product representation generator 360 can conform to a dimensionality including dimensions for input of grouped query data and dimensions for output query representations. In implementations, output product representation of the product representation generator 360 can be of a predefined dimension, perhaps a vector of a predefined dimensionality (e.g., conforming to a predefined length and/or conforming values to a predefined range). The product representations can be of a same dimensionality as the query product representation yielded by the generic query representation generator 350, making the representations input-string-length-invariant output vectors.

In implementations, the product representation generator 360 can be an inference model, perhaps the same type and/or same structure of model as the generic query representation generator 350. In implementations, the product representation generator trainer 334 trains the product representation generator 360 by an inference model training method, perhaps a same or a different inference model from the one used to train the generic query representation generator 350.

Although illustrated as being generated and stored in the service entity 330, one or more of the product representation generator 360 and product representation generator trainer 334 can be stored locally in a product supply entity's computing device. Alternatively or additionally, the one or more of the product representation generator 360 and product representation generator trainer 334 can be stored and/or trained in a dedicated client portion of memory of the service entity 330. For example, the one or more of the product representation generator 360 and the product representation generator trainer 334 can be stored in a secure portion of memory, dedicated secure hardware (such as a trusted execution environment secured from a rich execution environment of a larger server), a dedicated hardware memory location, or a dedicated virtual machine for the product supply entity 312.

Implementations are contemplated in which an existing product representation generator 360 can be updated by coalescing the product representation generator with one or more of an updated generic query representation generator 350, progressively supplied product data 340 over time, and further user search query data that would be used to train the generic query representation generator 350. In implementations, the product representation generator 360 is regenerated using the procedure used to originally generate the product representation generator 360 except that one or more of an updated generic query representation generator 350 is provided and new product data 340 is incorporated. In implementations, an updated product representation generator 360 is created using the procedure used to originally generate the product representation generator 360 except that one or more of an updated generic query representation generator 350 is provided and new product data 340 is incorporated. A combination of these methods can also be used. For example, a current version of a generic query representation generator 350 is used as a source for building the updated product representation generator 360 except that one or more of the user query data and the product data 340 received after the current version of the generic query representation generator 350 is generated is incorporated according to implementations disclosed in this specification. In another implementation, updates to the generic query representation generator 350 and the product representation generator 360 are made at different times.

In an implementation, after the product representation generator 360 has been trained, product data, such as product names can be inputted and corresponding product representations can be created for those products. To match the dimensionality of the input data used to train the product representation generator 360, the inputs can be padded (e.g., with zeroes or other default values or the inputs can include data representing repeats of the product data (e.g., products names), perhaps repeated in a different order or otherwise rearranged. If the dimensions of an input string or group are greater than the dimensions of the model's input dimensions, dimensionality reduction techniques (e.g., filtering, principal component analysis, and/or linear discriminant analysis) can be used.

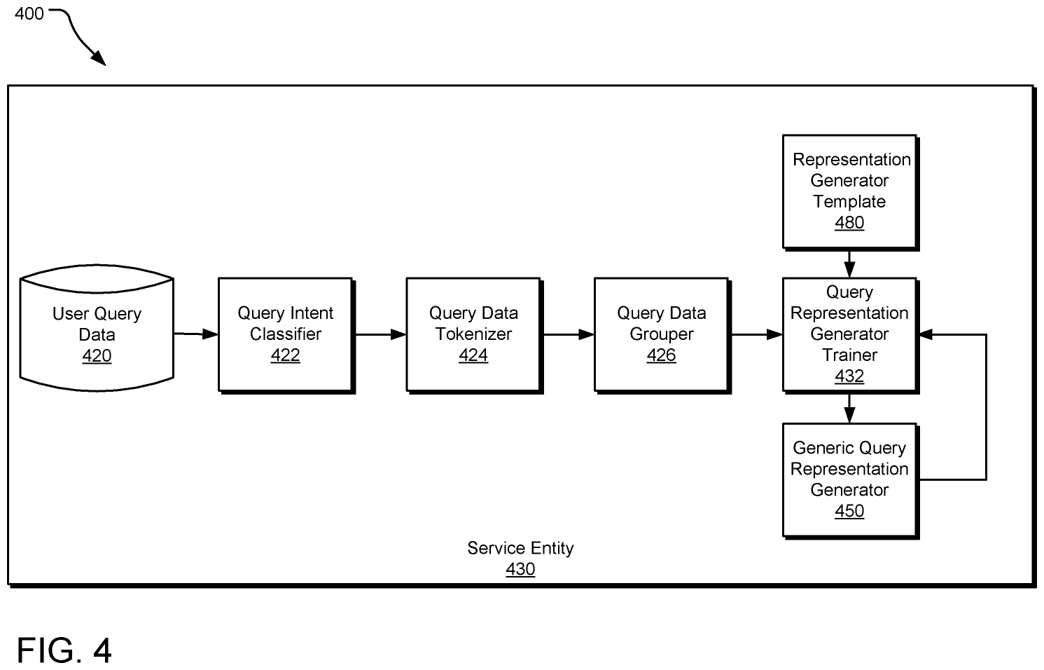

FIG. 4 illustrates another example of a system 400 for generating a generic query representation generator 450. A service entity 430 receives user query data 420, perhaps from a search provider. The user query data can be classified using a query intent classifier 422. The query intent classifier 422 is operable to determine a query intent. The query intent classifier 422 can classify which elements of the user query data 420 relate to products and can exclude any data not related to products.

The product-related data can be transferred from the query intent classifier 422 to the query data tokenizer 424. The query data tokenizer 424 tokenizes the user query data 420 to make the query data more ingestible for a generic query representation generator 450. Tokenization can include vectorizing elements of a string. Tokenization can be done based on different groupings of string characters. For example, tokenization can include one or more of sentence tokenization, search query tokenization (e.g., entire search string), word tokenization, character tokenization, subword tokenization, and byte-pair encoding. In this specification, tokenization can include preprocessing steps. Preprocessing steps can include, without limitation, one or more of regular expression (regX), Bag of Words, term frequency-inverse document frequency (TF-IDF), word embedding, word to vector (Word2Vec), Global Vectors for Word Representation (GloVe), Bert (or variations thereof) model embedding, Microsoft AGI model embedding, natural language toolkit text preprocessing, and/or any other preprocessing methods known and/or disclosed in this specification.

The query data tokenizer 424 can transfer the tokenized/preprocessed versions of the remaining user query data 420 to the query data grouper 426. The query data grouper 426 groups the user query data 420. The query data grouper 426 can group the user query data 420 based at least in part on a common characteristic of groups of the user query data 420. For example, grouping can be based on one or more of the user that generated the search query, the device that generated the search query, identifiers representing one or more of the device and user, a product classifier or category, a timing or order of queries (e.g., a request time), and a query classifier (e.g., one generated by the search provider). The grouping can include an ordered or hysteresis component in which the ordering of the user query data 420 grouped in the group is controlled and/or data representing order and/or timing of the user query data 420 is incorporated in the group. The grouped data representing strings with the common characteristic can be concatenated or otherwise grouped to make grouped strings, perhaps limited to a certain length. In implementations, the data representing the strings are windowed in input fields, limiting the number of and/or length of query strings in a grouped string. In implementations, the data can be grouped in chronological order to add a hysteresis component to the modeling. In various implementations, the grouping and the tokenizing can be done in any order.

The query data grouper 426 can transmit the group and other groups to the query representation generator trainer 432. In an implementation, the query representation generator trainer 432 can use the processed groups of search query strings to train the generic query representation generator 450. The query representation generator trainer 432 can begin with a representation generator template 480 baseline inference model with random weighting of different elements or can begin with a pre-trained model, perhaps trained in a different or similar context. The query representation generator trainer 432 can train the generic query representation generator 450 using any inference model and inference model training method, including ones disclosed in this specification.

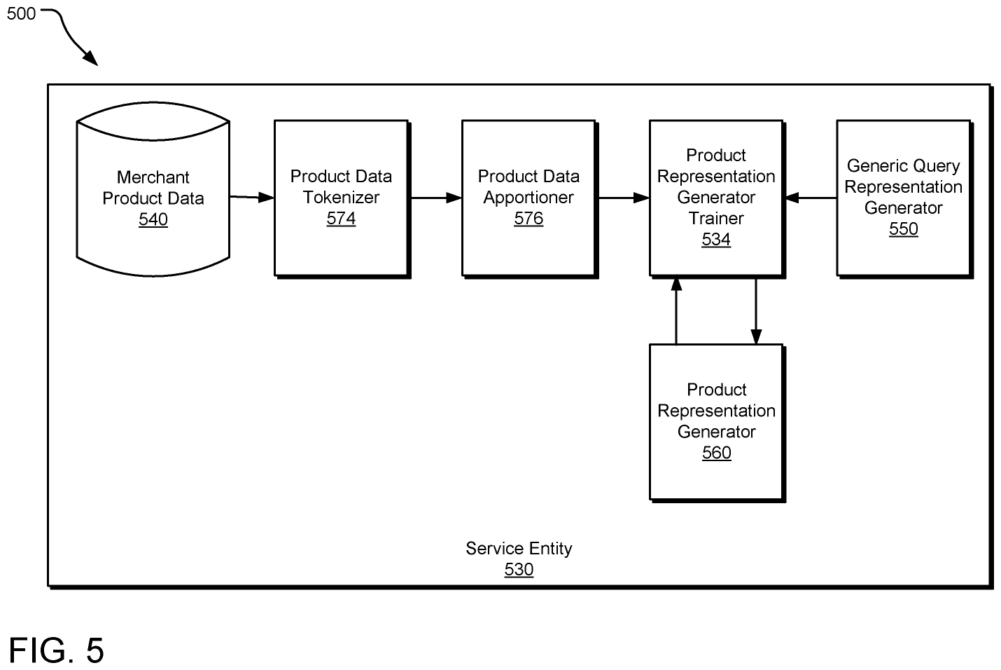

FIG. 5 illustrates another example of a system 500 for generating a product representation generator 560. A service entity 530 receives product data 540 from a product supply entity. The product-related data can be transferred to the product data tokenizer 574. The product data tokenizer 574 tokenizes the product data 540 to make the product data more ingestible for a generic query representation generator 550 and/or product representation generator 560. Tokenization can include vectorizing elements of a string. Tokenization can be done based on different groupings of string characters. For example, tokenization can include one or more of sentence tokenization, product string tokenization (e.g., entire product string), word tokenization, character tokenization, subword tokenization, and byte-pair encoding. In this specification, tokenization can include preprocessing steps. Preprocessing steps can include, without limitation, one or more of regular expression (regX), Bag of Words, term frequency-inverse document frequency (TF-IDF), word embedding, word to vector (Word2Vec), Global Vectors for Word Representation (GloVe), Bert (or variations thereof) model embedding, Microsoft AGI model embedding, natural language toolkit text preprocessing, and/or any other preprocessing methods known and/or disclosed in this specification. In implementations, the product data can be tokenized in the same manner as or a different manner from the manner in which user query data was tokenized to be prepared to train the generic query representation generator 550. For example, the tokenization can break words or other product data and/or identifiers into multiple sub tokens. Some implementations can benefit from treating product data and/or identifiers as sub tokens, and other can benefit from using the entire strings as single tokens. The choice of token size or content can be tuned based at least in part on performance of the models in associating related products and/or users. The performance can differ significantly for different inputs, so the product data being tokenized differently from the query data can potentially improve performance of the product representation generator 560.

The product data tokenizer 574 can transfer the tokenized/preprocessed versions of the product data 540 to the product data apportioner 576. The product data apportioner 576 groups the product data 540. The product data apportioner 576. In an implementation, the product representation generator trainer 534 can process the data by apportioning the product data 540. The product data 540 can be classified based on a common characteristic of portions of the product data 540. For example, apportioning can be based on one or more of the user that purchased the product, the device the user used to purchase the product, identifiers representing one or more of the device and user, a product identifier or category, queries within the product supply entity environment (e.g., product-related search strings in the product supply entity's system), and a timing or order of purchases or product queries (e.g., a request time). The apportioning can include an ordered or hysteresis component in which the order of the product data 540 apportioned in the portion of the product data 540 is controlled. In implementations, the product data can be apportioned in chronological order to add the hysteresis component to the modeling.

The product data apportioner 576 can also divide the portions into windowed portions by limiting the size of input portions to a limited size of product data 540. For example, the portion can be further reduced to sub-portions of the portions to make them smaller for ingestion into the generic query representation generator 550 and the product representation generator 560 generated therefrom. In implementations, the apportioning and the tokenizing can be done in any order.

The product data apportioner 576 can transfer the portion and other portions to the product representation generator trainer 534. In an implementation, the product representation generator trainer 534 uses the processed portions of product data 540 strings to train the generic query representation generator 550 to generate the product representation generator 560. The product representation generator trainer 534 can train the generic query representation generator 550 and/or the product representation generator 560 using any inference model and inference model training method, including ones disclosed in this specification. In implementations, outputs of the product representation generator 560 can be of a predefined dimension, perhaps a vector of a predefined dimensionality (e.g., conforming to a predefined length and/or conforming values to a predefined range). The product representations can be of a same dimensionality as the query product representation yielded by the generic query representation generator 550, making the product representations and query representations input-string-length-invariant output vectors.

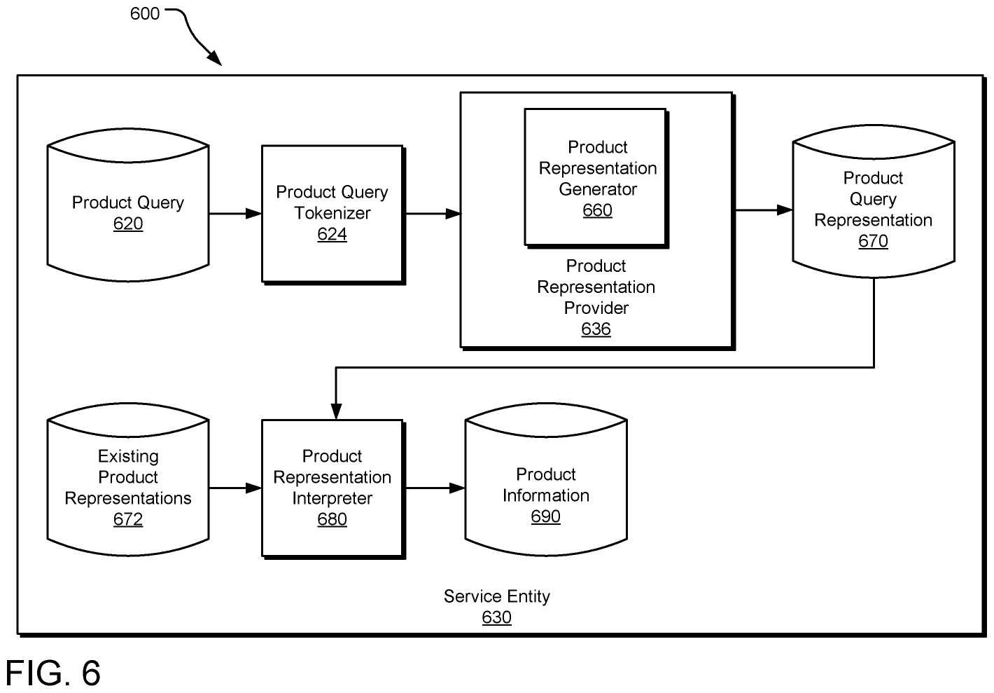

FIG. 6 illustrates an example system 600 for generating product information 690 from a product query 620. The product query 620 can be from a user (e.g., by initiating a search and/or a selection) or can be from a subsystem of the product supply entity or from a search provider. The product query 620 can be for a particular product or can be generally or indirectly related to a product (e.g., a moving service suggested if a user searches for homes out of state). The product query 620 can be tokenized, perhaps in a same manner as one or more of user query data used to train a generic query representation generator and product data used to train a product representation generator. In order to match the dimensionality of the input data used to train the product representation generator 660, the product query 620 inputs can be padded (e.g., with zeroes or other default values or the inputs can include data representing repeats of the product data (e.g., products names), perhaps repeated in a different order or otherwise rearranged. In implementations where the dimension of the input exceeds the model input dimension, dimensionality reduction techniques (e.g, filtering, principal component analysis, or linear discriminant analysis) can be used.

A product representation provider 636 inputs the preprocessed product query 620 into the product representation generator 660 and provides a product query representation 670. In implementations, outputs of the product representation generator 660 can be of a predefined dimension, perhaps a vector of a predefined dimensionality (e.g., conforming to a predefined length and/or conforming values to a predefined range). The product query representations 670 can be of a same dimensionality as any other query entered into the product representation generator 660, perhaps making the representations input-string-length-invariant output vectors.

The service entity 630 can store existing product representations 672 generated from product data provided by the service entity 630. Examples of product data used to generate the existing product representations 672 can include data representing one or more of product features, data for identifying products, general purchase data for products, user-specific purchase history data (perhaps include hysteresis or orders of purchases), prior product queries submitted by users to the product supply entity service, and seasonal purchase data. A product representation interpreter 680 can receive the product query representation 670 generated based at least in part on the product query 620 and compare the product query representation 670 with the existing product representations 672 to generate product information 690. The comparison can show that the product query representation 670 is similar to one or more of the existing product representations 672. For example, the product representation interpreter 680 can determine that the product query representation 670 is in a similar cluster as one or more of the existing product representations 672 and/or that a vector value of product query representation 670 is close to one or more vector values of the existing product representations 672. The product information 690 the product representation interpreter 680 provides can include data associated with the existing product representations 672 determined by the product representation interpreter 680 to be similar to the product query representation 670. The product information 690 can include product recommendations, perhaps product recommendations associated with the existing product representations 672 determined by the product representation interpreter 680 to be similar to the product query representation 670.

The product information can have applications beyond product recommendations. For example, in implementations, marketing teams can use data associated with a competitor, perhaps including the competitor's product list, in order to formulate marketing strategies. Marketing teams can also similarly identify potential or new competitors from the representations. Further, cohorts of users can be identified using clustering or other comparison techniques. The product/query representations can be generalized for new products as well, providing context where information is otherwise lacking. For example, a new product which did not exist in a category as classified can be added based at least in part on context provided by a representation. Also, even if a product is included in a category, the representation can function as an additional validation or even augment the existing product representation.

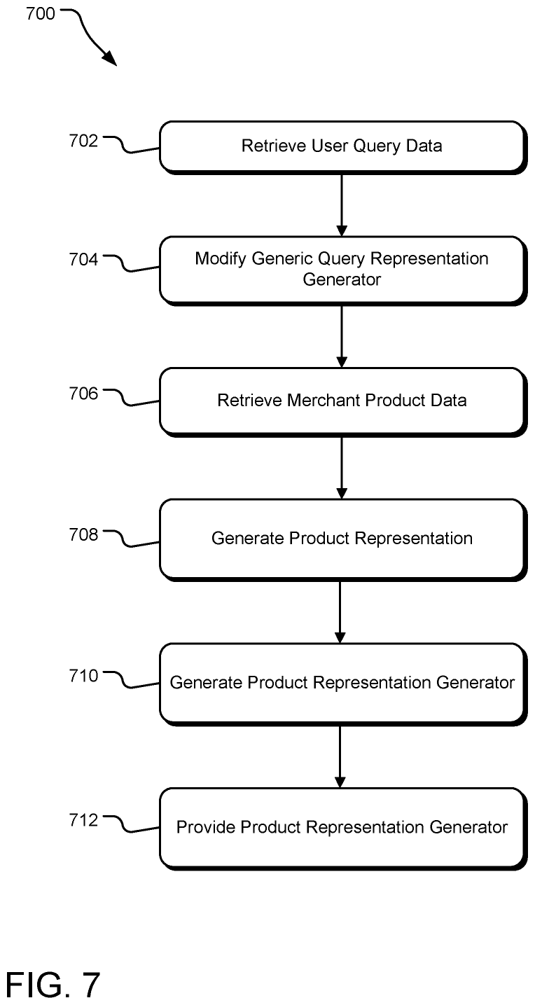

FIG. 7 illustrates example operations 700 of providing a product representation generator. Receiving operation 702 receives user query data including a plurality of search strings from a search provider. In implementations, the user query data can include user selection or click data associated with searches, perhaps including a selection of a result yielded from a search based on a search string (e.g., in a click graph). A service entity can receive the user query data from a search provider. The user query data can be received in and/or received from a service entity computing device (e.g., a server). Implementations are contemplated in which the search provider and the service entity are the same or different entities and/or conduct computational operations on the same or different computing device network. The service entity can include a query representation generator trainer executable by a processor of a computing device of the service entity to train a generic query representation generator, perhaps based at least in part on the received user query data. The service entity computing device can store the generic query representation generator in memory of the service entity computing device.

One or more of the query representation generator trainer, a query intent classifier, a query data tokenizer, and a query data grouper can process the user query data before using the user query data to train the generic query representation generator. In an implementation, the query user data can be processed by one or more of classified in order to exclude data that is not product-related, can be grouped, can be tokenized, and can be windowed.

Modifying operation 704 generates a generic query representation generator based at least in part on a group of the plurality of search strings. In an implementation, the modifying operation 704 uses a query representation generator trainer to train the generic query representation generator using the processed groups of search query strings. The training can be further based at least in part on selection or click data associated with the query strings. In implementations in which click or selection data is input with query data, the click or selection data can be input in a separate field from the string data. When no click or selection data (e.g., for product data not associated with a query) the separate field can be padded with zeroes or other data. The query representation generator trainer can begin with a representation generator template. The query representation generator trainer may train the query representation generator using a machine learning method from a representation generator template based at least in part on user query data supplied by a search provider. The query representation generator can be generic across multiple product supply entities

The representation generator template can be an inference or machine learning model, perhaps with random weighting of different elements or can begin with a pre-trained model, perhaps trained in a different or similar context. The query representation generator trainer can generate output for a group. The output can be a vector of a predefined length. The query representation generator trainer can modify the group by ignoring some of the data in the group. The data ignored can be data representing one or more search strings or elements of one or more search strings. The query representation generator trainer can input the modified group into the generic query representation generator to generate an output for the modified group. The output of the group and the output of the modified group can be compared (e.g., a distance between vectors can be calculated), and the loss or difference can be minimized (e.g., by propagating the loss through the generic query representation generator). This process can be continued within a group by making a different modified group, inputting the different modified group into the generic query representation generator, comparing the output of the different modified group with one or more of the output of the group and the output of the modified group, and minimizing the error or difference (e.g., by backpropagating the difference through the generic query representation generator). This process can be repeated for this and other groups any number of times. The result of the training can be a generic query representation generator capable of producing a query representation for any query input. The generic query representation generator can conform to a dimensionality including dimensions for input of grouped query data and dimensions for output query representations. In implementations, outputs of the generic query representation generator can be of a predefined dimension, perhaps a vector of a predefined dimensionality (e.g., conforming to a predefined length and/or conforming values to a predefined range). The product representations can be of a same dimensionality as the query product representation, making the representations input-string-length-invariant output vectors.

In implementations, the generic query representation generator can be an inference model. In implementations, the query representation generator trainer trains the generic query representation generator by an inference model training method.

Multiple instances of the generic query representation generator can exist simultaneously within the computing device(s) of the service entity. Implementations are contemplated in which the service entity continuously and/or periodically updates the generic query representation generator. The generic query representation generator can also be trained on product data used to generate a product representation generator. Implementations are contemplated where one or more of the generic query representation generator and a product representation generator can be coalesced to affect the other.

In an implementation, the generic query representation generator is trained using an inference method including an XLMRoBERTa model, and a product representation generator is trained using a BERT4REC model. Implementations are contemplated in which a query representation can be further processed as part of other OOB models. The OOB models can include ones for product recommendations, customer lifetime value, and churn to initialize the product representation in those models. The product or query representations can also be concatenated together to enrich the representation of a user using sequences of the user's product search.

In implementations, OOB models used for product recommendations, CLV, and churn take a user's purchase history as input of the model. The corresponding products may be input into the OOB model as the representation generated by the product representation generator 250 (e.g., as opposed to a contextless unique ID). This may provide the advantage that the representation has inborn context provided by the training of the product representation generator 250. In implementations, when a system has data representing multiple queries and/or purchases of a single user, a representation of the user can be made by coalescing or otherwise combining the representations of the queries and/or purchases (e.g., by averaging, taking a median of, or performing other combining algorithms on vector values of the representations). The resulting combined or coalesced representation may represent a characteristic representation of the user. This may provide a holistic aggregation of user search patterns and purchase history. A cohort (e.g., age, gender, location, or other demographic to which the user belongs) of the user can be inferred from demographic information and a representation can be used as a representation of the cohort and its members. In an implementation, the representation can capture recurring user activities, which can potentially be used to predict the churn of services.

Receiving operation 706 receives a plurality of product data from a product supply entity. Receiving operation 706 uses a service entity to receive product data received from a product supply entity. Examples of product data can include data representing one or more of product features, data for identifying products, general purchase data for products, user-specific purchase history data (perhaps include hysteresis or orders of purchases), and seasonal purchase data. A service entity provides product representation generation services for the product supply entity. One or more of the product representation generator trainer, a product data tokenizer, and a product data apportioner can process the product data for ingestion in the product representation generator. One or more of the product representation generator trainer, the product data tokenizer, and the product data apportioner can process the user product data before using the processed product data to train the generic query representation generator. In an implementation, the product data can be processed in order to exclude data that is not product-related, can be grouped, can be tokenized, and can be windowed.

Generating operation 708 generates a product representation using the modified query representation generator based at least in part on a portion of the plurality of product data. Generating operation can use the modified query representation generator to generate the product representation. The generating operation 708 can use a product representation generator trainer to input the processed product data into the product representation generator and output a product representation.

Generating operation 710 generates the product representation generator based at least in part on the product representation and the generic query representation generator. The product representation generator trainer can use the modified query representation generator as a base model (e.g., pre-trained model) from which to train and generate the product representation generator using a machine learning model. The product representation trainer can train the query representation generator to yield a product representation generator for the product supply entity from a query representation generator using a machine learning method based at least in part on a portion of the product data. The generic query representation generator can contextually include weighting of elements reflecting search query data. The product representation generator trainer can generate an output product representation for a portion. The output can be a vector of a predefined length. The product representation generator trainer can modify the portion by ignoring some of the data in the portion. The data ignored can be data representing one or more product data strings or elements of one or more product data strings. The product representation generator trainer that, when trained with the product data becomes the product representation generator) to generate an output for the modified portion. The output of the portion and the output of the modified portion can be compared (e.g., a distance between vectors can be calculated), and the loss or difference can be minimized (e.g., by propagating the loss through the generic query representation generator). The product representation generator trainer can make a different portion by ignoring different elements of the portion. This process can be continued within a portion by making the different modified portion, inputting the different modified portion into the generic query representation generator, comparing the output of the different modified portion with one or more of the output of the portion and the output of the modified portion, and minimizing the difference or loss. This process can be repeated for this and other portions any number of times. The result of the training can be a product representation generator capable of producing a product representation for any product data input. The product representation generator can conform to a dimensionality including dimensions for input of apportioned product data and dimensions for output portion representations. In implementations, outputs of the product representation generator can be of a predefined dimension, perhaps a vector of a predefined dimensionality (e.g., conforming to a predefined length and/or conforming values to a predefined range). The product representations can be of a same dimensionality as the query product representation yielded by the generic query representation generator, making the representations input-string-length-invariant output vectors.

In implementations, the product representation generator can be an inference or machine learning model, perhaps the same type and/or same structure of model as the generic query representation generator. In implementations, the product representation generator trainer trains the product representation generator by an inference or machine learning model training method, perhaps a same or a different inference model from the one used to train the generic query representation generator.

Providing operation 712 provides the product representation generator to a product supply entity. In implementations, one or more of the product representation generator and product representation generator trainer can be stored locally in a product supply entity's computing device, the providing operation 712 perhaps involving transmitting the product representation generator to the product supply entity's computing device. Alternatively or additionally, the providing operation 712 includes providing access to the product representation generator on the providing entity's computing devices. In this implementation, the one or more of the product representation generator and product representation generator trainer can be stored and/or trained in a dedicated client portion of memory of the service entity computing device. For example, the one or more of the product representation generator can be stored in a secure portion of memory, dedicated secure hardware (such as a trusted execution environment secured from a rich execution environment of a larger server), a dedicated hardware memory location, or a dedicated virtual machine for the product supply entity.

Implementations are contemplated in which an existing product representation generator can be updated by coalescing the product representation generator with one or more of an updated generic query representation generator, progressively supplied product data over time, and further user search query data that would be used to train the generic query representation generator. In implementations, the product representation generator is regenerated using the procedure used to originally generate the product representation generator except that one or more of an updated generic query representation generator is provided and new product data is incorporated. In implementations, an updated product representation generator is created using the procedure used to originally generate the product representation generator except that one or more of an updated generic query representation generator is provided and new product data is incorporated. A combination of these methods can also be used. For example, a current version of a query update generator is used as a source for building the updated product representation generator except that one or more of the user query data and the product data received after the current version of the generic query representation generator is generated is incorporated according to implementations disclosed in this specification. In another implementation, updates to the generic query representation generator and the product representation generator are made at different times.

In an implementation, after the product representation generator has been trained, product data, such as product names can be inputted and corresponding product representations can be created for those products. In order to match the dimensionality of the input data used to train the product representation generator, the inputs can be padded (e.g., with zeroes or other default values or the inputs can include data representing repeats of the product data (e.g., products names), perhaps repeated in a different order or otherwise rearranged. In implementations where the dimension of the input exceeds the model input dimension, dimensionality techniques (e.g., filtering, principal component analysis, or linear discriminant analysis) can be used.

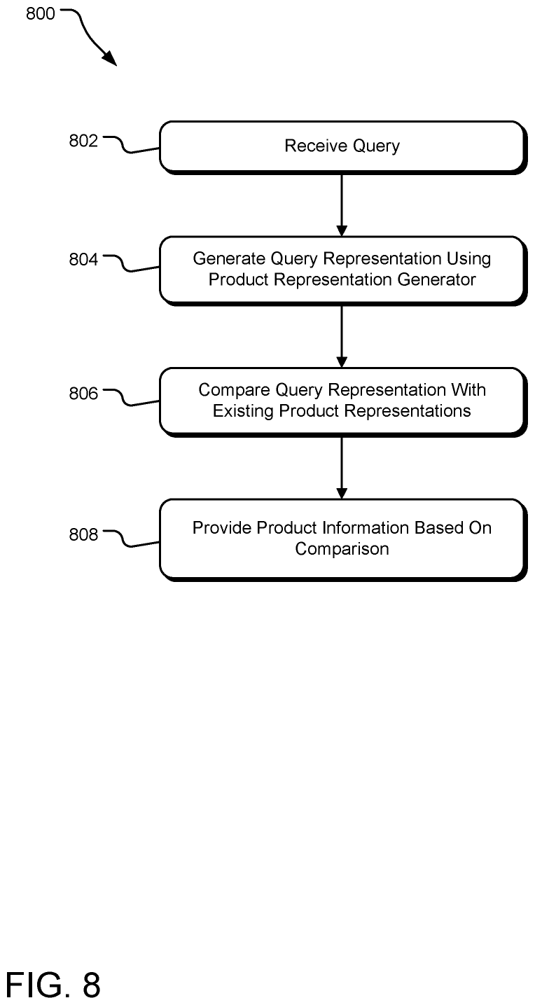

FIG. 8 illustrates example operations 800 of providing product information associated with a product representation. Receiving operation 802 receives a product query including a product query string. The product query can be from a user (e.g., by initiating a search and/or a selection) or can be from a subsystem of the product supply entity or from a search provider. The product query can be for a particular product or can be generally or indirectly related to the product (e.g., a moving service suggested if a user searches for homes out of state). The product query can be tokenized, perhaps in a same manner as one or more of user query data used to train a generic query representation generator and product data used to train a product representation generator. In order to match the dimensionality of the input data used to train the product representation generator, the inputs can be padded (e.g., with zeroes or other default values or the inputs can include data representing repeats of the product data (e.g., products names), perhaps repeated in a different order or otherwise rearranged. In implementations where the dimension of the input exceeds the model input dimension, dimensionality techniques (e.g., filtering, principal component analysis, or linear discriminant analysis) can be used.

Generating operation 804 generates a product query representation based at least in part on the product representation generator and the product query string. Generating operation 804 uses a product representation provider to input the preprocessed product query into the product representation generator and provide a product query representation. In implementations, outputs of the product representation generator can be of a predefined dimension, perhaps a vector of a predefined dimensionality (e.g., conforming to a predefined length and/or conforming values to a predefined range). The product query representations can be of a same dimensionality as any other query entered into the product representation generator, perhaps making the representations input-string-length-invariant output vectors.

The service entity can store existing product representations generated from product data provided by the service entity. Examples of product data used to generate the existing product representations can include data representing one or more of product features, data for identifying products, general purchase data for products, user-specific purchase history data (perhaps include hysteresis or orders of purchases), prior product queries submitted by users to the product supply entity service, and seasonal purchase data. A product representation interpreter can receive the product representation generated based at least in part on the product query and compare the product query representation with the existing product representations to generate product information. The comparison can show that the product query representation is similar to one or more of the existing product representations. For example, the product representation interpreter can determine that the product query representation is in a similar cluster as one or more of the existing product representations and/or that a vector value of product query representation is close to one or more vector values of the existing product representations. The product information the product representation interpreter provides can include data associated with the existing product representations determined by the product representation interpreter to be similar to the product query representation. The product information can include product recommendations, perhaps product recommendations associated with the existing representations determined by the product representation interpreter to be similar to the product query representation.

The product information can have applications beyond product recommendations. For example, in implementations, marketing teams can use data associated with a competitor, perhaps including the competitor's product list, in order to formulate marketing strategies. Marketing teams can also similarly identify potential or new competitors from the representations. Further, cohorts of users can be identified using clustering or other comparison techniques. The product/query representations can be generalized for new products as well, providing context where information is otherwise lacking. For example, a new product which did not exist in a category as classified can be added based at least in part on context provided by a representation. Also, even if a product is included in a category, the representation can function as an additional validation or even augment the existing product representation.

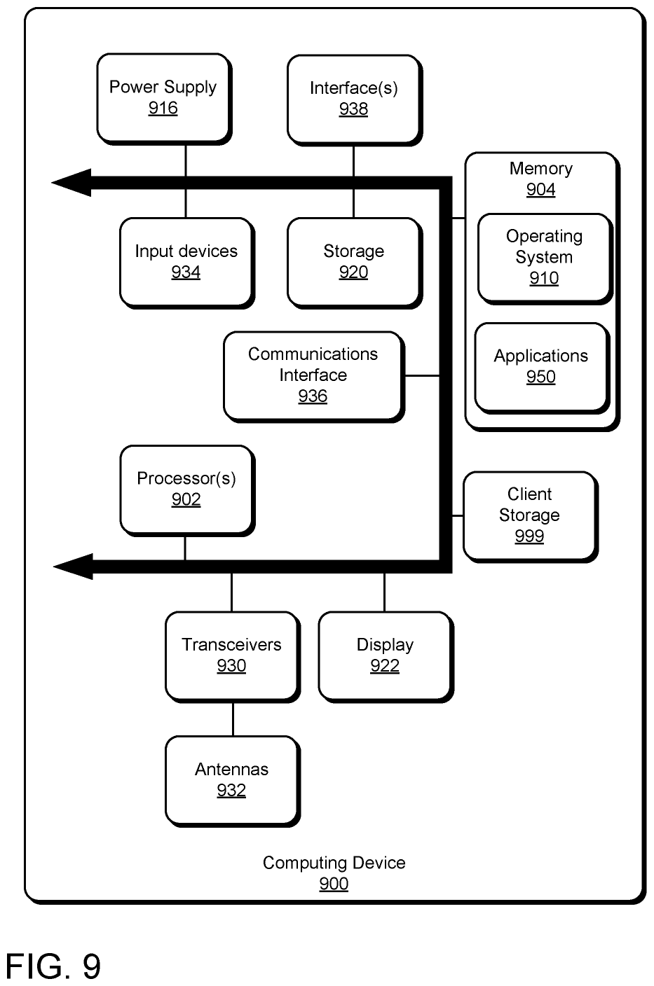

FIG. 9 illustrates an example computing device 900 for implementing the features and operations of the described technology. The computing device 900 can embody a remote-control device or a physical controlled device and is an example network-connected and/or network-capable device and can be a client device, such as a laptop, mobile device, desktop, tablet; a server/cloud device; an internet-of-things device; an electronic accessory; or another electronic device. The computing device 900 includes one or more processor(s) 902 and a memory 904. The memory 904 generally includes both volatile memory (e.g., RAM) and nonvolatile memory (e.g., flash memory). An operating system 910 resides in the memory 904 and is executed by the processor(s) 902. Any entities disclosed in this specification can each control computing devices 900 (e.g., server systems).

In an example computing device 900, as shown in FIG. 9, one or more modules or segments, such as applications 950, generic query representation generators, query representation generator trainers, search providers, inferential or machine learning methods or algorithms {e.g., masked learning modeling, unsupervised learning, supervised learning, reinforcement learning, self-learning, feature learning, sparse dictionary learning, anomaly detection, robot learning, association rule learning, manifold learning, dimensionality reduction, bidirectional transformation, unidirerctional transformation, gradient descent, autoregression, autoencoding, permutation language modeling, two-stream self attenuation, federated learning, absorbing transformer-XL, natural language processing (NLP), bidirectional encoder representations from transformers (BERT) models, RoBERTa, XLM-RoBERTa, and DistilBERT, ALBERT, CamemBERT, ConvBERT, DeBERTA, DeBERTA-v2, FlauBERT, I-BERT, herBERT, BertGeneration, BertJapanese, Bertweet, MegatronBERT, PhoBERT, MobileBERT, SqueezeBERT, BART, MBART, MBART-50BARThez, BORT, or BERT4REC), cross-lingual language model (XLM), XLNet, XLM-ProphetNet, XLSR-Wav2Vec2, Transformer XL, Auto Classe, BigBird, BigBirdPegasus, Blenderbot, Blenderbot Small, CLIP, CPM, CTRL, DeiT, DialoGPT, DPR, ELECTRA, Encoder Decoder Models, FSMT, Funnel Transformer, LayoutLM, LED, Longformer, LUKE, LXMERT, MarianMT, M2M100, MegatronGPT2, MPNet, MT5, OpenAI GPT, OpenAI GPT2, GPT Neo, Pegasus, ProphetNet, RAG, Reformer, Speech2Text, T5, TAPAS, Vision Transformer (ViT), and Wav2Vec2}, product representation generators, product representation generator trainers, query intent classifiers, query data tokenizers, query data groupers, product data tokenizers, product data apportioners, tokenization methods or algorithms, product query tokenizers, product representation providers, product representation interpreters, receivers, modifiers, generators, providers, receivers, comparers, classifiers, groupers, predictors, apportioners, user query data receivers, generic query representation generator modifiers, plurality of product data receivers, product representation generators, product representation generator generators, product representation providers, product query receivers, product query representation generators, representation comparers, product information providers, query intent classifiers, group generators, string predictors, group output data generators, modified group generators, modified group output generators, group comparers, are loaded into the operating system 910 on the memory 904 and/or storage 920 and executed by processor(s) 902. The storage 920 can include one or more tangible storage media devices and can store search queries, search query results, user query data, clicks, selections, selection data, click graphs, user purchase history, product data, groups of user query data, portions of product data, product queries, product query representations, product information, input-string-length-invariant output vectors, product strings, outputs of generic query representation generators, product query strings, common characteristics, inferential models (e.g., inferenatial or machine learning algorithms including one or more of data mining algorithms, artificial intelligence algorithms, masked learning models, natural language processing models, neural networks, artificial neural networks, perceptrons, feed forward networks, radial basis neural networks, deep feed forward neural networks, recurrent neural networks, long/short term memory networks, gated recurrent neural networks, auto encoders, variational auto encoders, denoising auto encoders, sparse auto encoders, Bayesian networks, regression models, decision trees, Markov chains, Hopfield networks, Boltzmann machines, restricted Boltzmann machines, deep belief networks, deep convolutional networks, genetic algorithms, deconvolutional neural networks, deep convolutional inverse graphics networks, generative adversarial networks, liquid state machines, extreme learning machines, echo state networks, deep residual networks, kohonen networks, support vector machines, federated learning models, and neural Turing machines), locally and globally unique identifiers, requests, responses, and other data and be local to the computing device 900 or can be remote and communicatively connected to the computing device 900.

The computing device 900 includes a power supply 916, which is powered by one or more batteries or other power sources and which provides power to other components of the computing device 900. The power supply 916 can also be connected to an external power source that overrides or recharges the built-in batteries or other power sources.

The computing device 900 can include one or more communication transceivers 930, which can be connected to one or more antenna(s) 932 to provide network connectivity (e.g., mobile phone network, Wi-Fi®, Bluetooth®) to one or more other servers and/or client devices (e.g., mobile devices, desktop computers, or laptop computers). The computing device 900 can further include a network adapter 936, which is a type of computing device. The computing device 900 can use the adapter and any other types of computing devices for establishing connections over a wide-area network (WAN) or local-area network (LAN). It should be appreciated that the network connections shown are examples and that other computing devices and means for establishing a communications link between the computing device 900 and other devices can be used.

The computing device 900 can include one or more input devices 934 such that a user can enter commands and information (e.g., a keyboard or mouse). These and other input devices can be coupled to the server by one or more interfaces 908, such as a serial port interface, parallel port, or universal serial bus (USB). The computing device 900 can further include a display 922, such as a touch screen display.

The computing device 900 can include a variety of tangible processor-readable storage media and intangible processor-readable communication signals. Tangible processor-readable storage can be embodied by any available media that can be accessed by the computing device 900 and includes both volatile and nonvolatile storage media, removable and non-removable storage media. Tangible processor-readable storage media excludes communications signals (e.g., signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 900. In contrast to tangible processor-readable storage media, intangible processor-readable communication signals can embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In an implementation, one or more of the product representation generator and product representation generator trainer can be stored locally in a product supply entity's computing device 900. Alternatively or additionally, the one or more of the product representation generator and product representation generator trainer can be stored and/or trained in a dedicated client storage 999 of a computing device 900 of a service entity. Examples of client storage 999 can include one or more of a secure portion of memory, dedicated secure hardware (such as a trusted execution environment secured from a rich execution environment of a larger server in which the operating system 910 is stored and/or which the operating system 910 may access), a dedicated hardware memory location, or a dedicated virtual machine for the product supply entity.

Various software components described herein are executable by one or more processors, which can include logic machines configured to execute hardware or firmware instructions. For example, the processors can be configured to execute instructions that are part of one or more applications, services, programs, routines, libraries, objects, components, data structures, or other logical constructs. Such instructions can be implemented to perform a task, implement a data type, transform the state of one or more components, achieve a technical effect, or otherwise arrive at a desired result.

Aspects of processors and storage can be integrated together into one or more hardware logic components. Such hardware-logic components can include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” can be used to describe an aspect of a remote-control device and/or a physically controlled device implemented to perform a particular function. It will be understood that different modules, programs, and/or engines can be instantiated from the same application, service, code block, object, library, routine, API, function, etc. Likewise, the same module, program, and/or engine can be instantiated by different applications, services, code blocks, objects, routines, APIs, functions, etc. The terms “module,” “program,” and “engine” can encompass individual or groups of executable files, data files, libraries, drivers, scripts, database records, etc.

It will be appreciated that a “service,” as used herein, is an application program executable across one or multiple user sessions. A service can be available to one or more system components, programs, and/or other services. In some implementations, a service can run on one or more server computing devices.

The logical operations making up embodiments of the invention described herein can be referred to variously as operations, steps, objects, or modules. Furthermore, it should be understood that logical operations can be performed in any order, adding or omitting operations as desired, regardless of whether operations are labeled or identified as optional, unless explicitly claimed otherwise or a specific order is inherently necessitated by the claim language.

An example method for managing query-based product representations is provided. The method includes receiving product data supplied by a product supply entity, wherein the product data is associated with one or more products for which the product supply entity provides information, generating a product representation generator for the product supply entity from a query representation generator including a machine learning model, wherein the product representation generator is trained from the query representation generator based at least in part on a portion of the product data, wherein the query representation generator was trained from a representation generator template based at least in part on user query data supplied by a search provider, wherein the query representation generator is generic across multiple product supply entities, and providing the product representation generator specific to the product supply entity, wherein the product representation generator is operable to relate a product data representation generated by the product representation generator to relevant search queries.

Another example method of any preceding method is provided, the method further including receiving the user query data including a plurality of search strings from the search provider and training the query representation generator based at least in part on a group of search strings in the user query data, wherein the operation of generating includes training the query representation generator using the group of search strings.

Another example method of any preceding method is provided, the method further including classifying a query intent of each of the plurality of search strings and generating the group of search strings based at least in part on whether the query intent is classified as product-related.

Another example method of any preceding method is provided, wherein the user query data further includes selection data associated with the plurality of search strings and wherein the operation of training the query representation generator is further based at least in part on the selection data.

Another example method of any preceding method is provided, wherein the operation of generating a product representation generator further includes apportioning the portion of the product data based at least in part on at least one common characteristic of the portion of the product data and generating a product data portion representation based at least in part on the portion of the product data and the product representation generator, and wherein the operation of generating the product representation generator further includes modifying the portion of the product data by ignoring a part of the portion of the product data, generating a modified product data portion representation based at least in part on the modified portion of the product data and the product representation generator, comparing the product data portion representation and the modified product data portion representation, and generating the product representation generator based at least in part on the comparison.

Another example method of any preceding method is provided, the method further including receiving a product query, generating a product query representation based at least in part on the product representation generator, comparing the product query representation with existing product representations generated by the product representation generator, and providing product information associated with one or more of the existing product representations, based at least in part on the comparison.

Another example method of any preceding method is provided, wherein each of the product data representation, an output of the query representation generator, and an output of the product representation generator include an input-string-length-invariant output vector of a predefined dimensionality.

An example computing device having a processor and a memory, the processor configured to execute instructions stored in memory is provided. The computing device includes a product data receiver executable by the processor to receive product data supplied by a product supply entity, wherein the product data is associated with one or more products for which the product supply entity provides information, a product representation generator trainer executable by the processor. The product representation generator trainer is to generate a product representation generator for the product supply entity from a query representation generator, based at least in part on a portion of the product data, wherein the query representation generator was trained from a representation generator template based at least in part on user query data supplied by a search provider, wherein the query representation generator is generic across multiple product supply entities and provide the product representation generator specific to the product supply entity, wherein the product representation generator is operable to relate a product data representation generated by the product representation generator to relevant search queries.

Another example computing device of any preceding device is provided, the computing device further including a query data receiver executable by the processor to receive the user query data including a plurality of search strings from the search provider and a query representation trainer executable by the processor to train the query representation generator based at least in part on a group of search strings in the user query data, wherein the generation includes training the query representation generator using the group of search strings.

Another example computing device of any preceding device is provided, the computing device further including a query intent classifier executable by the processor to classify a query intent of each of the plurality of search strings and a query data grouper executable by the processor to generate the group of search strings based at least in part on whether the query intent is classified as product-related.

Another example computing device of any preceding device is provided, the user query data further includes selection data associated with the plurality of search strings and wherein the operation of training the query representation generator is further based at least in part on the selection data.

Another example computing device of any preceding device is provided, the computing device further including a product data apportioner executable by the processor to apportion the portion of the product data based at least in part on at least one common characteristic of the portion of the product data. The product representation generator trainer is operable to generate a product data portion representation based at least in part on the portion of the product data and the product representation generator, modify the portion of the product data by ignoring a part of the portion of the product data, generate a modified product data portion representation based at least in part on the modified portion of the product data and the product representation generator, compare the product data portion representation and the modified product data portion representation and generate the product representation generator based at least in part on the comparison.

Another example computing device of any preceding device is provided, the computing device further including a product query receiver executable by the processor to receive a product query, wherein the product representation generator is configured to generate a product query representation based at least in part on the product representation generator a product representation interpreter executable by the processor. The product representation interpreter is to compare the product query representation with existing product representations generated by the product representation generator and provide product information associated with one or more of the existing product representations, based at least in part on the comparison.

Another example computing device of any preceding device is provided, wherein each of the product data representation, an output of the query representation generator, and an output of the product representation generator include an input-string-length-invariant output vector of a predefined dimensionality.

One or more example tangible processor-readable storage media embodied with instructions for executing on one or more processors and circuits of a computing device a process for managing query-based product representations is provided. The process includes receiving product data supplied by a product supply entity, wherein the product data is associated with one or more products for which the product supply entity provides information, generating a product representation generator for the product supply entity from a query representation generator, based at least in part on a portion of the product data, wherein the query representation generator was trained from a representation generator template based at least in part on user query data supplied by a search provider, wherein the query representation generator is generic across multiple product supply entities, and providing the product representation generator specific to the product supply entity, wherein the product representation generator is operable to relate a product data representation generated by the product representation generator to relevant search queries.

One or more other example tangible processor-readable storage media of any preceding media is provided. The process further includes receiving the user query data including a plurality of search strings from the search provider and training the query representation generator based at least in part on a group of search strings in the user query data, wherein the operation of modifying includes training the query representation generator using the group of search strings.

One or more other example tangible processor-readable storage media of any preceding media is provided, the process further including classifying a query intent of each of the plurality of search strings and generating the group of search strings based at least in part on whether the query intent is classified as product-related.

One or more other example tangible processor-readable storage media of any preceding media is provided the generation of a product representation generator further including apportioning the portion of the product data based at least in part on at least one common characteristic of the portion of the product data and generating a product data portion representation based at least in part on the portion of the product data and the product representation generator. The generating of the product representation generator further includes modifying the portion of the product data by ignoring a part of the portion of the product data, generating a modified product data portion representation based at least in part on the modified portion of the product data and the product representation generator, comparing the product data portion representation and the modified product data portion representation, and generating the product representation generator based at least in part on the comparison.

One or more other example tangible processor-readable storage media of any preceding media is provided, the process further including receiving a product query, generating a product query representation based at least in part on the product representation generator, comparing the product query representation with existing product representations generated by the product representation generator, and providing product information associated with one or more of the existing product representations, based at least in part on the comparison.

One or more other example tangible processor-readable storage media of any preceding media is provided, wherein each of the product data representation, an output of the query representation generator, and an output of the product representation generator include an input-string-length-invariant output vector of a predefined dimensionality.

An example system for managing query-based product representations is provided. The system includes means for receiving product data supplied by a product supply entity, wherein the product data is associated with one or more products for which the product supply entity provides information, means for generating a product representation generator for the product supply entity from a query representation generator including a machine learning model, wherein the product representation generator is trained from the query representation generator based at least in part on a portion of the product data, wherein the query representation generator was trained from a representation generator template based at least in part on user query data supplied by a search provider, wherein the query representation generator is generic across multiple product supply entities, and means for providing the product representation generator specific to the product supply entity, wherein the product representation generator is operable to relate a product data representation generated by the product representation generator to relevant search queries.

Another example system of any preceding system is provided, the system further including means for receiving the user query data including a plurality of search strings from the search provider and means for training the query representation generator based at least in part on a group of search strings in the user query data, wherein the generation includes training the query representation generator using the group of search strings.

Another example system of any preceding system is provided, the system further including means for classifying a query intent of each of the plurality of search strings and means for generating the group of search strings based at least in part on whether the query intent is classified as product-related.

Another example system of any preceding system is provided, wherein the user query data further includes selection data associated with the plurality of search strings and wherein the query representation generator is trained further based at least in part on the selection data.

Another example system of any preceding system is provided, wherein the means for generating a product representation generator further includes means for apportioning the portion of the product data based at least in part on at least one common characteristic of the portion of the product data and means for generating a product data portion representation based at least in part on the portion of the product data and the product representation generator, and wherein the means for generating the product representation generator further includes means for modifying the portion of the product data by ignoring a part of the portion of the product data, means for generating a modified product data portion representation based at least in part on the modified portion of the product data and the product representation generator, means for comparing the product data portion representation and the modified product data portion representation, and means for generating the product representation generator based at least in part on the comparison.

Another example system of any preceding system is provided, the system further including means for receiving a product query, means for generating a product query representation based at least in part on the product representation generator, means for comparing the product query representation with existing product representations generated by the product representation generator, and means for providing product information associated with one or more of the existing product representations, based at least in part on the comparison.

Another system of any preceding system is provided, wherein each of the product data representation, an output of the query representation generator, and an output of the product representation generator include an input-string-length-invariant output vector of a predefined dimensionality.

While this specification contains many specific implementation details, these should not be construed as limitations on the scope of any inventions or of what can be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

A number of implementations of the described technology have been described. Nevertheless, it will be understood that various modifications can be made without departing from the spirit and scope of the recited claims.

What is claimed is:

1. A method for managing query-based product representations, comprising:
receiving product data supplied by a product supply entity, wherein the product data is associated with one or more products for which the product supply entity provides information;
generating a product representation generator for the product supply entity from a query representation generator including a machine learning model, wherein the product representation generator is trained from the query representation generator based at least in part on a portion of the product data, wherein the query representation generator was trained from a representation generator template based at least in part on user query data supplied by a search provider, wherein the query representation generator is generic across multiple product supply entities; and
providing the product representation generator specific to the product supply entity, wherein the product representation generator is operable to relate a product data representation generated by the product representation generator to relevant search queries.

2. The method of claim 1, further comprising:
receiving the user query data including a plurality of search strings from the search provider; and
training the query representation generator based at least in part on a group of search strings in the user query data, wherein the operation of generating includes training the query representation generator using the group of search strings.

3. The method of claim 2, further comprising:
classifying a query intent of each of the plurality of search strings; and
generating the group of search strings based at least in part on whether the query intent is classified as product-related.

4. The method of claim 2, wherein the user query data further includes selection data associated with the plurality of search strings and wherein the operation of training the query representation generator is further based at least in part on the selection data.

5. The method of claim 1, the operation of generating a product representation generator further comprising:
apportioning the portion of the product data based at least in part on at least one common characteristic of the portion of the product data; and
generating a product data portion representation based at least in part on the portion of the product data and the product representation generator, and
wherein the operation of generating the product representation generator further comprising:
modifying the portion of the product data by ignoring a part of the portion of the product data;
generating a modified product data portion representation based at least in part on the modified portion of the product data and the product representation generator;
comparing the product data portion representation and the modified product data portion representation; and
generating the product representation generator based at least in part on the comparison.

6. The method of claim 1, further comprising:
receiving a product query;
generating a product query representation based at least in part on the product representation generator;
comparing the product query representation with existing product representations generated by the product representation generator; and
providing product information associated with one or more of the existing product representations, based at least in part on the comparison.

7. The method of claim 1, wherein each of the product data representation, an output of the query representation generator, and an output of the product representation generator include an input-string-length-invariant output vector of a predefined dimensionality.

8. A computing device having a processor and a memory, the processor configured to execute instructions stored in memory, the computing device, comprising:
a product data receiver executable by the processor to receive product data supplied by a product supply entity, wherein the product data is associated with one or more products for which the product supply entity provides information;
a product representation generator trainer executable by the processor to:
generate a product representation generator for the product supply entity from a query representation generator, based at least in part on a portion of the product data, wherein the query representation generator was trained from a representation generator template based at least in part on user query data supplied by a search provider, wherein the query representation generator is generic across multiple product supply entities; and
provide the product representation generator specific to the product supply entity, wherein the product representation generator is operable to relate a product data representation generated by the product representation generator to relevant search queries.

9. The computing device of claim 8, further comprising:
a query data receiver executable by the processor to receive the user query data including a plurality of search strings from the search provider; and
a query representation trainer executable by the processor to train the query representation generator based at least in part on a group of search strings in the user query data, wherein the generation includes training the query representation generator using the group of search strings.

10. The computing device of claim 9, further comprising:
a query intent classifier executable by the processor to classify a query intent of each of the plurality of search strings; and
a query data grouper executable by the processor to generate the group of search strings based at least in part on whether the query intent is classified as product-related.

11. The computing device of claim 9, wherein the user query data further includes selection data associated with the plurality of search strings and wherein the operation of training the query representation generator is further based at least in part on the selection data.

12. The computing device of claim 8, further comprising:
a product data apportioner executable by the processor to apportion the portion of the product data based at least in part on at least one common characteristic of the portion of the product data, wherein the product representation generator trainer is operable to:
generate a product data portion representation based at least in part on the portion of the product data and the product representation generator;
modify the portion of the product data by ignoring a part of the portion of the product data;
generate a modified product data portion representation based at least in part on the modified portion of the product data and the product representation generator;
compare the product data portion representation and the modified product data portion representation; and
generate the product representation generator based at least in part on the comparison.

13. The computing device of claim 8, further comprising:
a product query receiver executable by the processor to receive a product query, wherein the product representation generator is configured to generate a product query representation based at least in part on the product representation generator; and
a product representation interpreter executable by the processor to:
compare the product query representation with existing product representations generated by the product representation generator; and
provide product information associated with one or more of the existing product representations, based at least in part on the comparison.

14. The computing device of claim 8, wherein each of the product data representation, an output of the query representation generator, and an output of the product representation generator include an input-string-length-invariant output vector of a predefined dimensionality.

15. One or more tangible processor-readable storage media embodied with instructions for executing on one or more processors and circuits of a computing device a process for managing query-based product representations, the process comprising:
receiving product data supplied by a product supply entity, wherein the product data is associated with one or more products for which the product supply entity provides information;
generating a product representation generator for the product supply entity from a query representation generator, based at least in part on a portion of the product data, wherein the query representation generator was trained from a representation generator template based at least in part on user query data supplied by a search provider, wherein the query representation generator is generic across multiple product supply entities; and
providing the product representation generator specific to the product supply entity, wherein the product representation generator is operable to relate a product data representation generated by the product representation generator to relevant search queries.

16. The one or more tangible processor-readable storage media of claim 15, the process further comprising:
receiving the user query data including a plurality of search strings from the search provider; and
training the query representation generator based at least in part on a group of search strings in the user query data, wherein the operation of generating includes training the query representation generator using the group of search strings.

17. The one or more tangible processor-readable storage media of claim 16, the process further comprising:
classifying a query intent of each of the plurality of search strings; and
generating the group of search strings based at least in part on whether the query intent is classified as product-related.

18. The one or more tangible processor-readable storage media of claim 15, the operation of generating a product representation generator further comprising:
apportioning the portion of the product data based at least in part on at least one common characteristic of the portion of the product data; and
generating a product data portion representation based at least in part on the portion of the product data and the product representation generator, and
wherein the operation of generating the product representation generator further comprising:
modifying the portion of the product data by ignoring a part of the portion of the product data;
generating a modified product data portion representation based at least in part on the modified portion of the product data and the product representation generator;
comparing the product data portion representation and the modified product data portion representation; and
generating the product representation generator based at least in part on the comparison.

19. The one or more tangible processor-readable storage media of claim 15, the process further comprising:
receiving a product query;
generating a product query representation based at least in part on the product representation generator;
comparing the product query representation with existing product representations generated by the product representation generator; and
providing product information associated with one or more of the existing product representations, based at least in part on the comparison.

20. The one or more tangible processor-readable storage media of claim 15, wherein each of the product data representation, an output of the query representation generator, and an output of the product representation generator include an input-string-length-invariant output vector of a predefined dimensionality.
